(19) United States
(12) Patent Application Publication
(10) Pub. No.: US 2011/0234036 A1
(43) Pub. Date: Sep. 29, 2011

(54) Green generator

(76) Inventor: Roberto Torres, Hackensack, NJ (US)

(21) Appl. No.: 13/065,589

(22) Filed: Mar. 24, 2011

Related U.S. Application Data
(60) Provisional application No. 61/340,970, filed on Mar. 25, 2010.

(51) Int. Cl. H02K 47/04; H02K 53/00

(52) U.S. Cl. 310/113; 74/DIG. 9

(57) ABSTRACT

The present invention, hereinafter referred as the Green Generator provides this input with a battery-powered motor, the driveshaft of this motor in turn linked by belt-and-pulleys to an alternator and a generator and, in another embodiment, equipped with a Direct Current to Alternating Current inverter, to provide household emergency power, and to simultaneously provide Direct Current to continually recharge the battery.

### CLAIM OF PRIORITY

This patent application claims priority under 35 USC 119 (e) (1) from U.S. Provisional Patent Application Serial No. 61/340,970 filed 03/25/2010, of common inventorship herewith entitled, “GREEN GENERATOR.”

### FIELD OF THE INVENTION

The present invention pertains to the field of electrical generators, and more specifically to the field of continuous electrical generator devices.

### BACKGROUND OF THE INVENTION

The prior art has put forth several designs for electrical generator devices. Among these are:

U.S. Pat. No. 5,751,091 to Osamu Takahashi, et at describes a power generator, which includes a piezoelectric transducer, which generates electric power upon application of a strain. The power generator includes a vibrating arm having a sandwich structure wherein a support layer is held between at least two piezoelectric portions.

U.S. Pat. No. 5,874,798 to Thomas G. Wiegele, et al describes a micro-turbo generator device including a housing, a rotor, a plurality of stator cores, and coils encircling the stator cores. Each rotor pole includes a magnetizable tip and a concave fluid impact surface.

U.S. Pat. No. 6,320,280 to Toshiya Kanesaka describes a thermoelectric generator in a housing for generating electric power in response to a temperature difference across the thermoelectric generator.

None of these prior art references describe the present invention.

### SUMMARY OF THE INVENTION

It is an object of the present invention to provide an improved electrical generator device.

### BRIEF DESCRIPTION OF THE DRAWINGS

FIG. 1 shows both an elevational left and right angled perspective view of the device of the present invention.

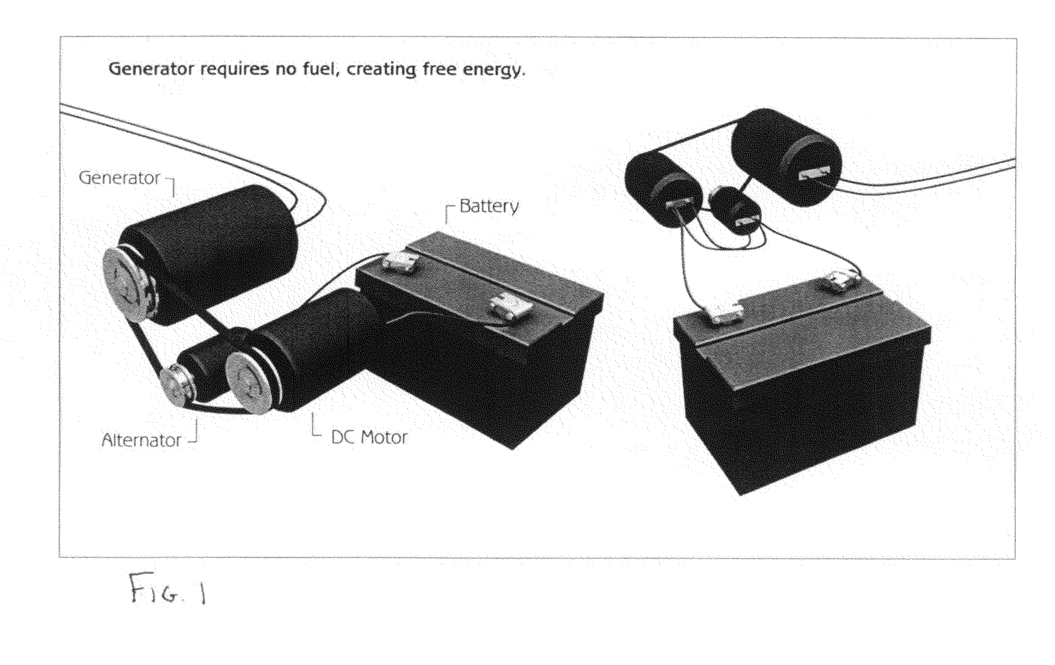

FIG. 2 is a schematic diagram showing the operation of the generator of the present invention.

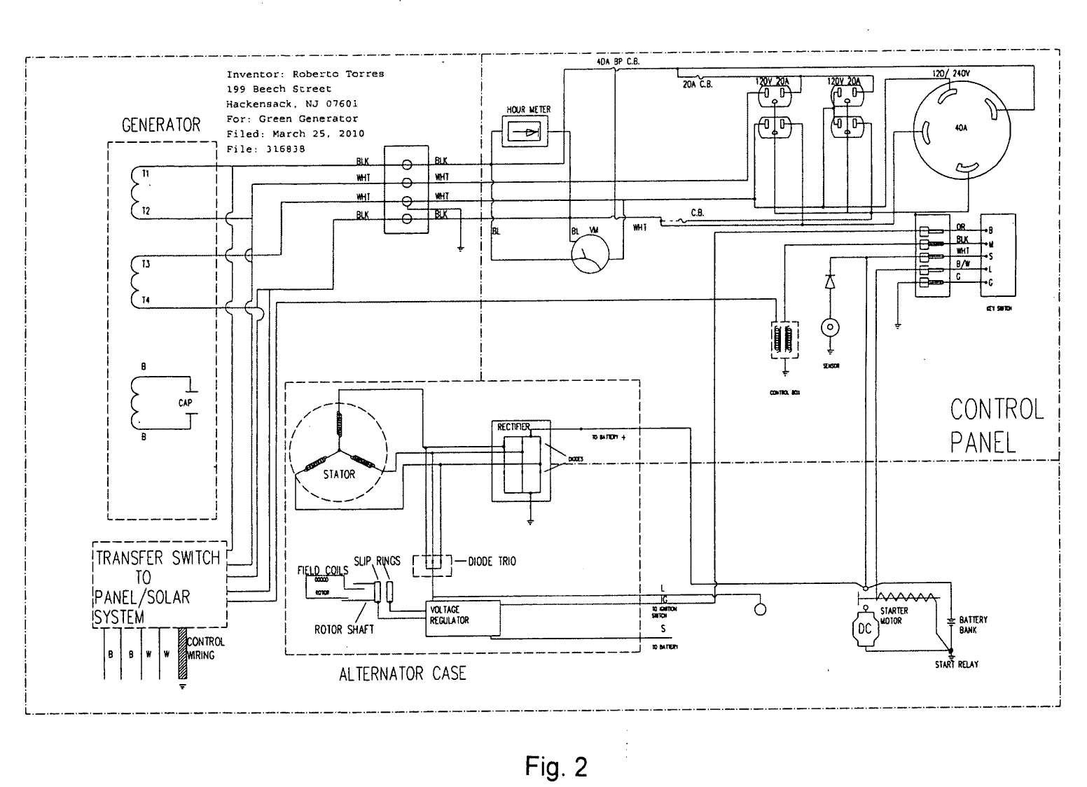

### DETAILED DESCRIPTION OF THE INVENTION

In a world hungry for clean and efficient sources of energy, inventors and engineers have turned their efforts toward capturing virtually unlimited supplies of energy from moving winds, sunlight, the ocean tides, the nuclei of atoms, and other “renewables” that might replace our current dependence on finite supplies of the fossil fuels, coal, oil, natural gas, methane, oil sands and shale, bound up in Earth's sedimentary rocks. Beyond the search for new energy sources, inventors and engineers seek ever-higher levels of efficiency in the energy-converting machines we rely upon, from hybrid automobiles to household electric appliances. An automobile takes the chemical potential energy of gasoline and, through the heat of combustion and the expansion of gases, converts that potential energy into the kinetic energy that turns the driveshaft and moves the car. Batteries, too, are a source of potential energy. When connected to an electrical circuit, batteries release a stream of electrons, an electric current, which is then converted into work. In a simple generator, a coil of conducting wire is placed between two magnets and spun, inducing an electric current. In the contemporary world, generators range from the huge hydroelectric turbines that power cities to the gas-powered emergency generators that consumers use during power outages, to the generators which help to maintain the charge in our car batteries. All generators, however, depend on a motive force to spin their coils. The force of flowing water rotates the fins in a hydroelectric turbine, and the fins in turn rotate a revolving shaft that rotates the coils. Gas-powered generators use an internal combustion engine and a driveshaft to rotate the coils, and the coils in a car's generator are spun by a driveshaft connected to a belt driven by the engine. Thus, to generate electricity, a generator requires an input of kinetic, or mechanical, energy.

The present invention, hereinafter referred as the Green Generator provides this input with a battery-powered motor, the driveshaft of this motor in turn linked by belt-and-pulleys to an alternator and a generator and, in another embodiment, equipped with a Direct Current to Alternating Current inverter, to provide household emergency power, and to simultaneously provide Direct Current to continually recharge the battery.

The Green Generator is “green” in the sense that, once started by the flow of Direct Current from the battery, it is continuously operating, and requires no further energy or fuel input. The system of the present invention requires only that the battery bear an initial charge to set the system in motion, thereafter, the system functions indefinitely as a closed loop, requiring no further energy input from outside the system.

The Green Generator system is assembled from components manufactured by the Motors and Generators industry, Standard Industrial Code 3621 and the battery in which the generated current is stored is manufactured by the Storage Batteries industry, Standard Industrial Code 3691.

There are two embodiments of the Green Generator system, both of which start with Direct Current from the storage battery and end by providing Alternating Current to power household appliances, lights, and so forth. In the first embodiment, the storage battery provides Direct Current to an electric motor. This motor spins a driveshaft and pulley, and the pulley turns a belt which in turn spins the pulley of an alternator, which recharges the storage battery, and a generator, which then provides one hundred twenty or two hundred forty volts of Alternating Current for emergency household use. The second embodiment is similar, but instead of producing Alternating Current through a generator, this embodiment sends Direct Current through an inverter, again producing one hundred twenty/two hundred forty volts of Alternating Current. In yet another embodiment, a solar panel is incorporated into the system, which assists in recharging the storage battery.

The Green Generator is a “closed-loop” or self-contained system. The storage battery provides the current to power the motor and drives the alternator and generator, yet continually recharges by the returning flow of current from the alternator.

The Green Generator presents several significant and distinct benefits to householders. Foremost, the Green Generator requires only an electric battery for power, and no gasoline. The Green Generator therefore releases no exhaust gases or particulate emissions into the atmosphere, and therefore produces no air pollution. Further, because the Green Generator does not burn hydrocarbon fossil fuels, this technology helps to reduce our nation's dependence on fossil fuels, and thus on foreign sources of oil, a huge consideration, with oil at more than a hundred dollars a barrel and our country largely dependent on oil from world regions hostile to our interests, even our survival.

This clean and energy-efficient, electrically powered generator, promotes the goals of cleaner energy, a cleaner planet and atmosphere, and lower reliance of fossil fuels and foreign energy sources, goals of tremendous benefit to all consumers.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

Claims:

1. An improved electrical generator device, comprising a battery-powered motor, wherein the driveshaft of this motor is linked by belt-and-pulleys to an alternator and a generator.

2. The improved electrical generator device of claim 1 further comprising a Direct Current to Alternating Current inverter, to provide household emergency power, and to simultaneously provide Direct Current to continually recharge the battery.

3. The improved electrical generator device of claim 1 which starts with Direct Current from a storage battery which provides Direct Current to an electric motor, wherein the motor spins a driveshaft and motor pulley, and the motor pulley turns a belt which in turn spins the pulley of an alternator, which recharges the storage battery, and a generator.

4. The device of claim 1 wherein the generator provides one hundred twenty volts of Alternating Current for emergency household use.

5. The device of claim 1 wherein the generator provides two hundred forty volts of Alternating Current for emergency household use.

6. The device of claim 1, wherein the generator sends Direct Current through an inverter, producing one hundred twenty volts of Alternating Current.

7. The device of claim 1, wherein the generator sends Direct Current through an inverter, producing two hundred forty volts of Alternating Current.

8. The device of claim 1, further comprising a solar panel is incorporated into the system, and the solar panel is used for recharging a storage battery.
